(19) United States
(12) Patent Application Publication
(10) Pub. No.: US 2007/0252715 A1
(43) Pub. Date: Nov. 1, 2007

(54) Liquid quality and level sensor

(75) Inventors: Gangi Rajula Reddy, Bangalore (IN); Raviprakash Thotadakumbri, Bangalore (IN)

Correspondence Address: Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/414,052

(22) Filed: Apr. 27, 2006

(51) Int. Cl. G01F 23/26; G08B 21/00

(52) U.S. Cl. 340/620; 73/304 C

(57) ABSTRACT

Sensor components deployed in a container and acting as resistors or capacitors are used to determine liquid level independent of liquid quality. Displacement current can also be considered as the conduction current to accurately measure liquid quality and level. As the level of liquid increases, the displacement current and conduction current increases, which in turn causes a large change in output for a small change in liquid level. The change in displacement and conduction current values due to contamination of the liquid can be taken in to account with the help of auxiliary electrodes. The contaminated liquid level can be measured very accurately by current flowing through primary electrodes along with the use of auxiliary electrodes for auxiliary measurement, resulting in enhanced sensor system sensitivity and accuracy. System liquid level accuracy is independent of liquid quality and measures liquid quality accurately with resistance, displacement current, conduction current and capacitive measurement.

### TECHNICAL FIELD

Embodiments are generally related to sensors, sensing methods and sensing systems. Embodiments are also related to liquid quality sensing devices. Embodiments are additionally related to liquid level sensors. Embodiments also relate to methods and systems for linear and rotary sensing applications. Embodiments additionally relate to combined quality and level sensor for use with liquid measurements.

### BACKGROUND

Traditional liquid level sensors uses capacitive technology, wherein two electrodes are placed in the container to measure its liquid level. This system of measuring liquid levels has the following limitations: the accuracy of the liquid level varies with the quality of the liquid because of the change in capacitance due to change in the value of dielectric constant. the accuracy is very poor with contaminated liquid level measurement; and the quality of the liquid can not be measured. It is believed these issues can be counteracted using the current invention.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved sensor methods and systems.

It is another aspect of the present invention to provide for an improved liquid quality detection sensor.

It is a further aspect of the present invention to provide for an improved liquid level sensor.

The invention can also measure the quality of liquid along with level of the liquid. In accordance with another feature of the embodiments, the current invention describes the high conductive liquid level and quality sensing by Resistive technology considering the quality of the liquid in to account. Resistance between the electrodes (P1 & P2) is much dependent on the level of the conductive liquid. Auxiliary electrodes (P3 & P4) help in finding the variation in conductivity of the liquid due to contamination and correct it for the liquid level measurement. The auxiliary electrodes not only measure the quality of liquid (considering the change in conductivity with the contamination) but also help in accurately measuring the contaminated liquid level.

It is an additional aspect of the present invention to consider the usage of the two capacitors instead of one, to accurately measure a contaminated dielectric liquid level within a container. The container can include two capacitors; one is an auxiliary capacitor (formed with the electrodes P3 and P4) to measure the contamination, the other one is the main capacitor (formed with the electrodes P1 and P2) to measure the liquid level.

The aforementioned aspects of the invention and other objectives and advantages can now be achieved as described herein. A liquid quality and level sensor system is disclosed, which includes a system that considers the usage of the product of displacement current and conduction current to measure the liquid level. As the level of liquid increases, the displacement current and conduction current increases which in turn causes a large change in output for a small change in liquid level. This technique is very useful, because sometimes the liquid may be pure dielectric or pure conductive or both partially dielectric and partially conductive. The change in displacement and conduction current values due to contamination of a liquid can be taken in to account with the help of auxiliary electrodes (P3 & P4). The contaminated liquid level can be measured very accurately with the main capacitor along with the auxiliary capacitor, with the product of displacement current and conduction current. The sensor system also can provide enhanced sensitivity, accuracy and resolution.

In accordance with an additional feature of the present invention, chemical levels & quality can be measured, oil quality and levels can be measured, and milk levels & quality can be measured.

### BRIEF DESCRIPTION OF THE DRAWING

The accompanying figure, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a side view of a level and quality sensor system including the use of resistors, conduction current, capacitors or displacement current to obtain measurements in accordance with features of the present invention.

FIG. 2 illustrates a side view of an alternate configuration for a level and quality sensor system including the use of resistors, conduction current, capacitors or displacement current to obtain measurements in accordance with features of the present invention.

FIG. 3 illustrates a side view of another alternate configuration for a level and quality sensor system including the use of resistors, conduction current, capacitors or displacement current to obtain measurements in accordance with features of the present invention.

FIG. 4 illustrates a flow diagram of operations for a level and quality sensor system wherein sensors are operable as resistors in accordance with features of the present invention.

FIG. 5 illustrates a flow diagram of operations for a level and quality sensor system wherein sensors are operable for conduction current measurements in accordance with features of the present invention.

FIG. 6 illustrates a flow diagram of operations for a level and quality sensor system wherein sensors are operable as capacitors in accordance with features of the present invention.

FIG. 7 illustrates a flow diagram of operations for a level and quality sensor system wherein sensors are operable for displacement current measurements in accordance with features of the present invention.

FIG. 8 illustrates a flow diagram of operations for a level and quality sensor system wherein sensors are operable for measuring the liquid level with high sensitivity and resolution in accordance with features of the present invention.

FIG. 9 illustrates a flow diagram of operations for a level and quality sensor system wherein sensors are operable for measuring the quality of liquid along with the level of the liquid in a container using resistance in accordance with features of the present invention.

### DETAILED DESCRIPTION

The particular values and configurations discussed in these non-limiting examples can be varied and are cited merely to illustrate at least one embodiment and are not intended to limit the scope of the invention.

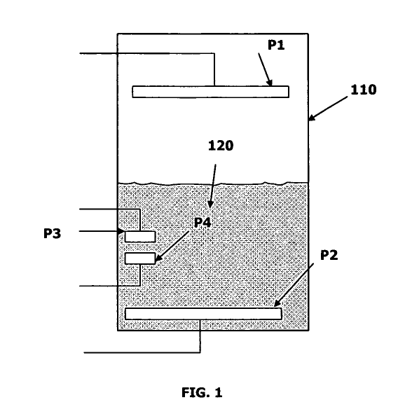

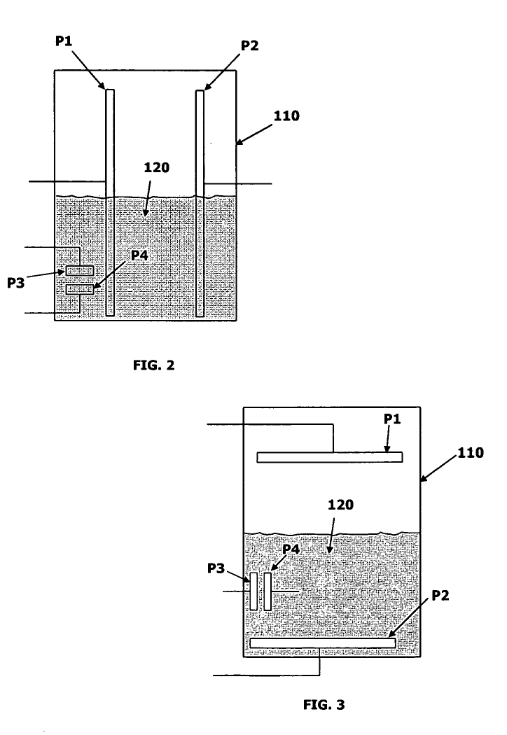

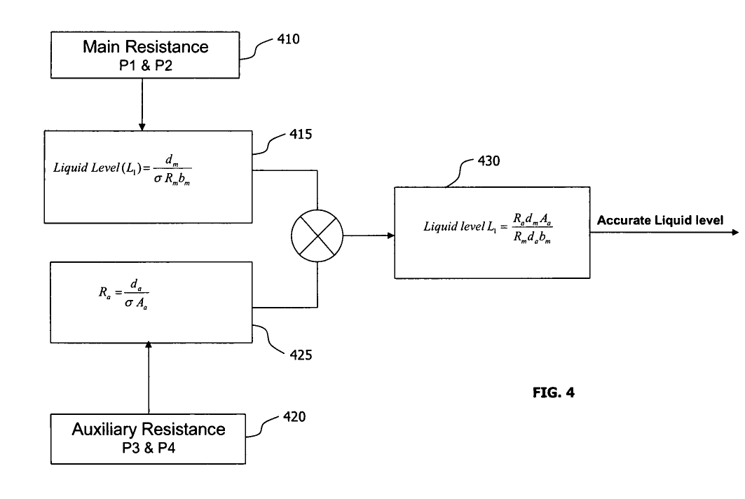

FIG. 1 illustrates a side view of a level and quality sensor system. For a highly contaminated liquid there are two unknowns, one is the liquid level another one is the conductivity and permitivity of the liquid. A container 110 filled with a liquid 120 includes at least one electrode pair, P1-P2 and/or P3-P4, operable to provide measurements of at least one of resistance, capacitance or current values for a liquid held by the container 110. Referring to FIGS. 2 and 3, alternative configurations of electrode pairs within container 110 and operable to carry out sensing functions described herein are also shown.

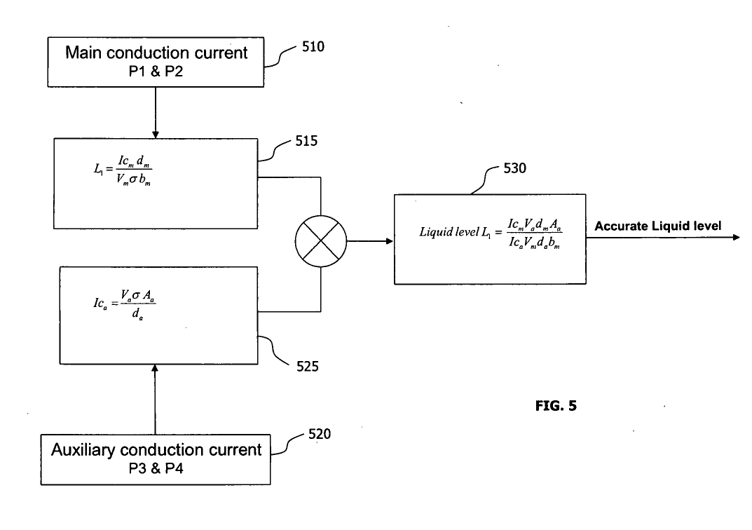

Referring to FIG. 4, & FIG. 2 when operable as a resistor, the first electrode set P1 & P2 shown in Block 410 operates as the main resistor used for liquid level measurement. The second electrode set P3 & P4 shown in Block 420 can be operable as an auxiliary resistor introduced in the container to manage variations in liquid conductivity. The first resistance can be dependent on variation in liquid level and is dependent to the variation in conductivity due to contamination.

The net resistance of the main resistor at liquid level L, is given, as shown in Block 415, by:

$$Liquid Level ( {L}_{1} ) = \frac{{d}_{m}}{σ {R}_{m} {b}_{m} } \qquad ( 1 )$$

where, bₘ=width of the electrodes P1 & P2
L=Length of the electrode P1 & P2
L₁=Length of the Liquid
Rₘ=Measured main resistance
dₘ=Distance between the electrodes P1 & P2
σ=Conductivity of the liquid.

For a pure liquid the only unknown is the liquid level L₁. This can be found from equation 1. For the contaminated liquid there are two unknowns one is L₁ and other is σ, so it is difficult to find the contaminated liquid level accurately with single resistance.

The auxiliary resistor resistance is given, as shown in Block 425, by:

$${R}_{a} = \frac{{d}_{a}}{σ {A}_{a}} \qquad ( 2 )$$

where Aₐ=Area of the electrodes P3 & P4, and dₐ=Distance between the auxiliary electrodes P3 & P4. Substituting equation 2 in equation 1 provides the following equation:

$$Liquidlevel {L}_{1} = \frac{{R}_{a} {d}_{m} {A}_{a}}{{R}_{m} {d}_{a} {b}_{m}} \qquad ( 3 )$$

As shown in Block 430, by substituting the measured main resistance and auxiliary resistance along with the geometrical parameters, the level of the liquid can measured very accurately and is independent of the quality of liquid.

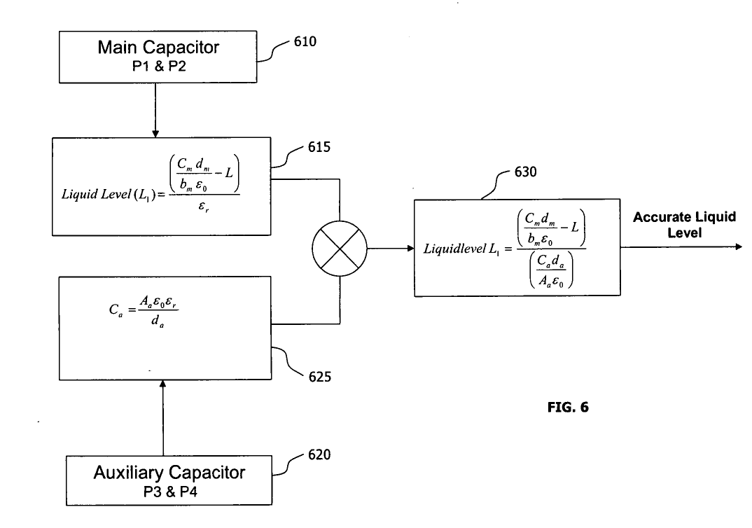

Referring to FIG. 5 & FIG. 2, when operable as a conduction current measurement, the conduction current from first electrode set P1 & P2 shown in Block 510 can be used for liquid level measurement. The conduction current from second electrode set P3 & P4 shown in Block 520 can be used to correct the variation in liquid quality. So the conduction current measured from the first set of electrodes gives accurate liquid level dependent of liquid quality, where as the second set of electrodes measures the liquid quality.

The Main conduction current at liquid level L₁ is given, as shown in Block 515, by:

$${L}_{1} = \frac{{Ic}_{m} {d}_{m}}{{V}_{m} σ {b}_{m}} \qquad ( 4 )$$

where,
Vₘ=Applied voltage to the main electrodes
Icₘ=Measured main conduction current
bₘ=width of the electrodes P1 & P2
L₁=Length of the Liquid
dₘ=Distance between the electrodes P1 & P2
σ=Conductivity of the liquid.

For a pure liquid the only unknown is the liquid level L₁. This can be found from equation 4. For the contaminated liquid there are two unknowns one is L₁ and other is σ, so it is difficult to find the contaminated liquid level accurately with single resistance.

The auxiliary conduction current is given, as shown in Block 525, by:

$${Ic}_{a} = \frac{{V}_{a} σ {A}_{a}}{{d}_{a}} \qquad ( 5 )$$

where Aₐ=Area of the electrodes P3 & P4, and dₐ=Distance between the auxiliary electrodes P3 & P4. As shown in Block 530, by substituting equation 5 in equation 4, the following equation is provided:

$$Liquidlevel {L}_{1} = \frac{{Ic}_{m} {V}_{a} {d}_{m} {A}_{a}}{{Ic}_{a} {V}_{m} {d}_{a} {b}_{m}} \qquad ( 6 )$$

By substituting the measured main conduction current and auxiliary conduction current along with the geometrical parameters, the level of the liquid can measured very accurately and is independent of the quality of liquid.

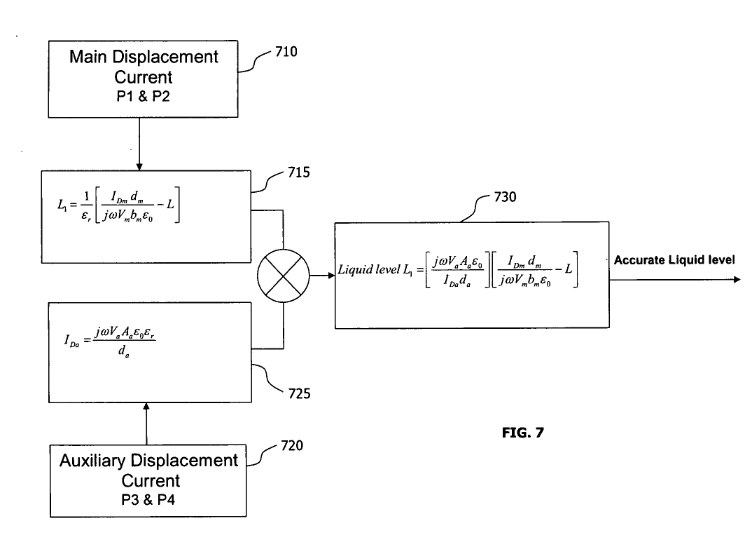

Referring to FIG. 6 & FIG. 2, when operable as a capacitor, the first electrode set P1 & P2 shown in Block 610 can operate as the main capacitor used for liquid level measurement. The second electrode set P3 & P4 shown in Block 620 can be operable as a second capacitor is an auxiliary capacitor introduced in the container to manage variations in liquid permitivity. So the first capacitance is dependent on variation in liquid level as well as independent to the variation in permittivity due to contamination.

The net capacitance of the main capacitor at liquid level L₁ is given, shown in Block 615, by:

$$Liquid Level ( {L}_{1} ) = \frac{( \frac{{C}_{m} {d}_{m}}{{b}_{m} {ɛ}_{0}} - L )}{{ɛ}_{r}} \qquad ( 7 )$$

where, bₘ=width of the electrodes P1 & P2
L=Length of the electrode P1 & P2
L₁=Length of the Liquid
Cₘ=Measured main capacitance
dₘ=Distance between the electrodes P1 & P2
εᵣ=Permitivity of the liquid.

For a pure liquid the only unknown is the liquid level L₁. This can be found from equation 7. For the contaminated liquid there are two unknowns one is L₁ and other is εᵣ, so it is difficult to find the contaminated liquid level accurately with single capacitance.

The auxiliary capacitor capacitance is given, as shown in Block 625, by:

$${C}_{a} = \frac{{A}_{a} {ɛ}_{0} {ɛ}_{r}}{{d}_{a}} \qquad ( 8 )$$

where Aₐ=Area of the electrodes P3 & P4, and dₐ=Distance between the auxiliary electrodes P3 & P4. As shown in Block 630, by substituting equation 8 in equation 7 provides the following equation:

$$Liquidlevel {L}_{1} = \frac{( \frac{{C}_{m} {d}_{m}}{{b}_{m} {ɛ}_{0}} - L )}{( \frac{{C}_{a} {d}_{a}}{{A}_{a} {ɛ}_{0}} )} \qquad ( 9 )$$

By substituting the measured main capacitance and auxiliary capacitance along with the geometrical parameters, the level of the liquid can measured very accurately and is independent of the quality of liquid.

Referring to FIG. 7 & FIG. 2, when operable as a displacement current measurement, the displacement current from first electrode set P1 & P2 shown in Block 710 can be used for liquid level measurement. The displacement current from second electrode set P3 & P4 shown in Block 720 can be used to correct the variation in liquid quality. So the displacement current measured from the first set of electrodes gives accurate liquid level dependent of liquid quality, where as the second set of electrodes measures the liquid quality.

The Main displacement current at liquid level L₁ is given, shown in Block 715, by:

$${L}_{1} = \frac{1}{{ɛ}_{r}} [ \frac{{I}_{Dm} {d}_{m}}{jω {V}_{m} {b}_{m} {ɛ}_{0}} - L ] \qquad ( 10 )$$

where,
I_{Dm}=Measured main displacement current
Vₘ=Applied voltage to the main electrodes
bₘ=width of the electrodes P1 & P2
L₁=Length of the Liquid
dₘ=Distance between the electrodes P1 & P2
εᵣ=Permitivity of the liquid.

For a pure liquid the only unknown is the liquid level L₁. This can be found from equation 10. For the contaminated liquid there are two unknowns one is L₁ and other is εᵣ, so it is difficult to find the contaminated liquid level accurately with single measured displacement current.

The auxiliary displacement current is given, as shown in Block 725, by:

$${I}_{Da} = \frac{jω {V}_{a} {A}_{a} {ɛ}_{0} {ɛ}_{r}}{{d}_{a}} \qquad ( 11 )$$

where Aₐ=Area of the electrodes P3 & P4, and dₐ=Distance between the auxiliary electrodes P3 & P4. As shown in Block 730, by substituting equation 11 in equation 10 provides the following equation:

$$Liquidlevel {L}_{1} = [ \frac{jω {V}_{a} {A}_{a} {ɛ}_{0}}{{I}_{Da} {d}_{a}} ] [ \frac{{I}_{Dm} {d}_{m}}{jω {V}_{m} {b}_{m} {ɛ}_{0}} - L ] \qquad ( 12 )$$

By substituting the measured main conduction current and auxiliary conduction current along with the geometrical parameters, the level of the liquid can measured very accurately and is independent of the quality of liquid.

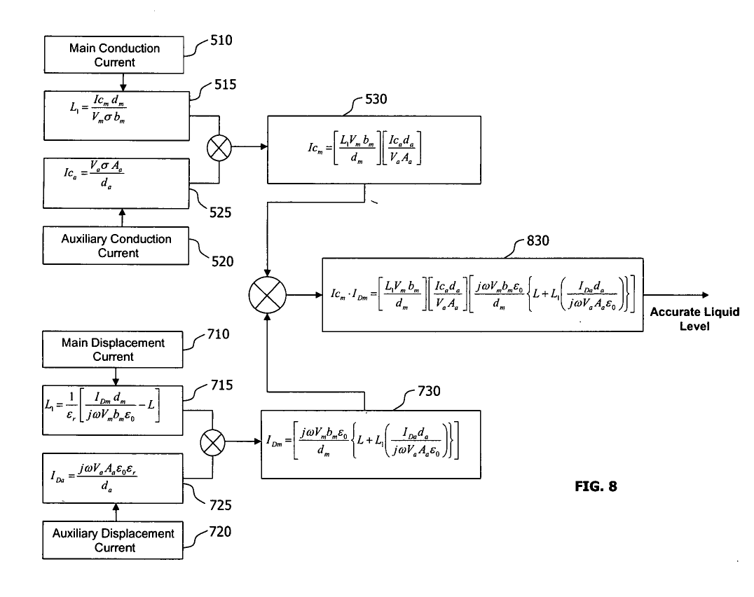

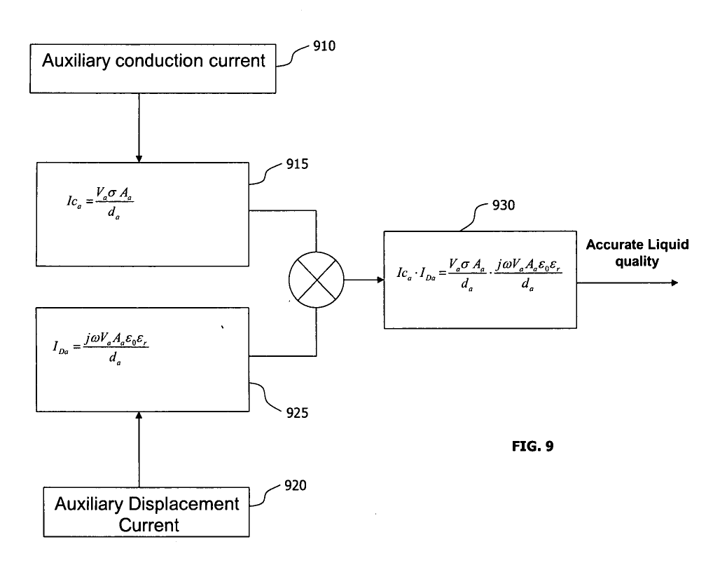

Referring to FIG. 8 & FIG. 2, the product of displacement current and conduction current can be used to measure the liquid level with high sensitivity and resolution. This kind of measurement helps in identifying any kind of the liquid (either dielectric or conductive) level, independent of its quality.

$$I {c}_{m} \cdot {I}_{Dm} = [ \frac{{L}_{1} {V}_{m} σ {b}_{m}}{{d}_{m}} ] [ \frac{jω {V}_{m} {b}_{m} {ɛ}_{0}}{{d}_{m}} \{ L + {L}_{1} {ɛ}_{r} \} ] \qquad ( 13 )$$

From the equation (13), as the level of liquid increases the displacement current and conduction current increases, which in turn causes a large change in output for a small change in liquid level. The change in displacement and conduction current values due to contamination of the liquid can be taken in to account with the help of auxiliary electrodes (P3 & P4), as shown in Block 830 and also calculated below.

$$I {c}_{m} \cdot {I}_{Dm} = [ \frac{{L}_{1} {V}_{m} {b}_{m}}{{d}_{m}} ] [ \frac{I {c}_{a} {d}_{a}}{{V}_{a} {A}_{a}} ] [ \frac{jω {V}_{m} {b}_{m} {ɛ}_{0}}{{d}_{m}} \{ L + {L}_{1} ( \frac{{I}_{D a} {d}_{a}}{jω {V}_{a} {A}_{a} {ɛ}_{0}} ) \} ] \qquad ( 14 )$$

The contaminated liquid level can be measured very accurately by current flowing through the main electrodes (P1 & P2) along with the use of auxiliary electrodes (P3 & P4) for a current measurement, resulting in enhanced sensor system sensitivity, accuracy and resolution.

Referring to FIG. 9, the present invention can also measure the quality of liquid along with level of the liquid using resistance, capacitance, and the product of auxiliary conduction current 910 and auxiliary displacement current 920 measuring techniques. The product of Auxiliary displacement current as shown calculated in Block 925, and conduction current, shown calculated in Block 915, is given by equation 15, also shown in Block 930.

$$I {c}_{{a}^{+}} {I}_{Da} = [ \frac{{V}_{a} σ {A}_{a}}{{d}_{a}} ] [ \frac{jω {V}_{a} {A}_{a} {ɛ}_{0} {ɛ}_{r}}{{d}_{a}} ] \qquad ( 15 )$$

The contamination of the liquid either can increase the product of conduction current and displacement current or as well decrease the product depending upon the type of contamination. The auxiliary electrodes can not only measure the quality of liquid (considering the change in conductivity with the contamination) but can also help in accurately measuring the contaminated liquid level using resistance, capacitance, conduction current, or displacement current measuring technologies.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A liquid level and quality sensor system, comprising a container adapted to retain a liquid including a first electrode pair functioning as a primary sensor component useful for liquid level measurement and a second electrode pair functioning as an auxiliary sensor component useful for managing variations in liquid conductivity.

2. The system of claim 1 wherein at least one of said first and second electrode pairs is operable to provide measurements of capacitance values for a liquid held by the container.

3. The system of claim 2 wherein capacitance between at least one of said first and second electrode pair is dependent on the level of the liquid.

4. The system of claim 2 wherein capacitance between the auxiliary sensor component is used to determine variation in permitivity of the liquid due to contamination.

5. The system of claim 4 wherein the auxiliary sensor component can be used to measure contaminated liquid levels.

6. The system of claim 1 wherein the first sensor component represents a resistor with a resistance is dependent on variations in liquid level as well as variations in conductivity.

7. The system of claim 6 wherein the net resistance of the first set of electrodes at a liquid level L1 is given by:
$$Liquid Level ( {L}_{1} ) = \frac{{d}_{m}}{σ {R}_{m} {b}_{m}}$$
wherein bₘ is equal to the width of the electrodes P1 & P2, L₁ is equal to the length (height) of the Liquid, Rₘ is equal to measured main resistance, dₘ is equal to the distance between electrodes P1 & P2, and σ is equal to the conductivity of the liquid; and the resistance between the auxiliary electrodes is given by:
wherein Aₐ=Area of
$${R}_{a} = \frac{{d}_{a}}{σ {A}_{a}}$$
the electrodes P3 & P4, and dₐ=distance between the auxiliary electrodes P3 & P4.

8. The system of claim 6 wherein the level of the liquid can accurately measured independent of the quality of liquid by substituting auxiliary resistance into net resistance provides as follows:
$$Liquidlevel {L}_{1} = \frac{{R}_{a} {d}_{m} {A}_{a}}{{R}_{m} {d}_{a} {b}_{m}}$$

9. A liquid level and quality sensor system, comprising a container adapted to retain a liquid including a first electrode pair P1 & P2 disposed vertically along the height of the container and a second electrode pair P3 & P4 disposed near the inside bottom of the container, wherein the first and second electrode pairs are useful to measure at least one of resistance, capacitance or current between each contact pair when liquid is contained within the container to determine at least one of the quality or level of liquid in the container.

10. The system of claim 9 wherein resistance measured between the first and second electrode pairs is dependent on variations in liquid level as well as variations in conductivity.

11. The system of claim 9 wherein at least one electrode pair is operable to provide measurements of capacitance, resistance or current values for a liquid held by the container.

12. The system of claim 11 wherein the first electrode pair P1 & P2 is operable as a primary resistor used for liquid level measurement.

13. The system of claim 11 wherein the second electrode set P3 & P4 is operable as an auxiliary resistor introduced useful to manage variations in liquid conductivity.

14. The system of claim 12 wherein the first resistance is dependent on variation in liquid level as well as the variation in conductivity.

15. The system of claim 9 wherein at least one electrode pair is operable to provide measurements of current values for a liquid held by the container.

16. The system of claim 15 wherein displacement current and conduction current measured from at least one electrode pair is used to measure liquid level in the container, wherein as the level of a liquid contained in the container increases, the displacement current and conduction current increases.

17. The system of claim 16 wherein the change in displacement and conduction current values due to contamination of the liquid is taken in to account with the help of auxiliary electrodes, wherein contaminated liquid levels are measured with current flowing through the primary electrodes along with use of auxiliary electrodes for a current measurement.

18. A method of sensing liquid level and quality, comprising:
determining at least one of resistance, capacitance or current between a first electrode pair disposed vertically along the inside of a container adapted for holding a liquid;
determining at least one of resistance, capacitance or current between a second electrode pair disposed near the inside bottom of the container;
comparing measurements of at least one of capacitance, resistance or current determined between the first and second electrode pairs; and.
determining at least one of liquid quality or liquid level for liquid contained in the container.

19. The method of claim 18, wherein capacitance is measured at the first and second electrode pairs, and wherein net capacitance between the first electrode pair at a liquid level L1 is given by:
$$Liquid Level ( {L}_{1} ) = \frac{( \frac{{C}_{m} {d}_{m}}{{b}_{m} {ɛ}_{0}} - L )}{{ɛ}_{r}}$$
wherein bₘ is equal to the width of the electrodes P1 & P2, L is equal to the length of the electrode P1 & P2, L₁ is equal to the length (height) of the Liquid, Cₘ is equal to measured main capacitance, dₘ is equal to the distance between electrodes P1 & P2, and εᵣ is equal to the permitivity of the liquid; and the auxiliary capacitor capacitance is given by:
$${C}_{a} = \frac{{A}_{a} {ɛ}_{0} {ɛ}_{r}}{{d}_{a}}$$
wherein Aₐ=Area of the electrodes P3 & P4, and dₐ=distance between the auxiliary electrodes P3 & P4.

20. The method of claim 19 wherein the level of the liquid is be measured independent of the quality of liquid by substituting auxiliary capacitance into net capacitance provides as follows:
$$Liquidlevel {L}_{1} = \frac{( \frac{{C}_{m} {d}_{m}}{{b}_{m} {ɛ}_{0}} - L )}{( \frac{{C}_{a} {d}_{a}}{{A}_{a} {ɛ}_{0}} )}$$
